(19) United States
(12) Patent Application Publication
(10) Pub. No.: US 2010/0096484 A1
(43) Pub. Date: Apr. 22, 2010

(54) Lock elements for preventing rotary shafts of shredder from bending

(75) Inventor: Jia-Wang Jiang, NingBo City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/289,050

(22) Filed: Oct. 20, 2008

(51) Int. Cl. B02C 23/04

(52) U.S. Cl. 241/285.1

(57) ABSTRACT

This specification discloses a lock element for preventing the rotary shafts of shredders from bending. The lock element includes fixing ends and a supporting arm. The fixing element is used to fix on the paper guiding chips of the shredder mechanism. The supporting arm strides and urges on the outer side of the shredder mechanism. In practice, the lock elements are used in pairs and symmetrically fixed on the paper guiding chips. They form a pinching effect on the shredder mechanism to prevent the rotary shafts from bending.

### BACKGROUND OF THE INVENTION

1. Field of Invention

The invention relates to a shredder and, in particular, to lock elements that prevent the rotary shafts of a shredder from bending.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

A usual shredder includes a housing, a paper inlet on the front surface of the housing for inserting paper, and a shredder mechanism disposed inside the housing for shredding paper. The shredder mechanism includes cutting blades mounted on two parallel rotary shafts driven by a motor and a gearbox, thereby cutting passing paper into stripes or chips.

Any given shredder has a sheet capacity according to its motor load and the strengths of the cutting blades and rotary shafts. When a lot of paper needs to be destroyed, the user has to follow the sheet capacity when inserting paper. Otherwise, inserting too much paper at a time can easily cause a paper jam. Moreover, the rotary shafts may bend when it is overloaded. If no appropriate supporting components are provided on the outer sides of the rotary shafts to balance the bending moment, the rotary shafts may even break, making the shredder out of order.

Therefore, to prevent the rotary shafts from bending under a large external force, it is necessary to provide appropriate supporting components on the outer sides of the rotary shafts.

### SUMMARY OF THE INVENTION

In view of the foregoing, an objective of the invention is to provide lock elements for preventing the rotary shafts of the shredder from bending.

To achieve the above-mentioned objective, the disclosed lock element includes fixing ends and a supporting arm. The fixing end is used to fix with the paper guiding chips of the shredder mechanism. The supporting arm strides and urges on the outer side of the shredder mechanism. In practice, the lock elements are used in pairs and symmetrically fixed on the paper guiding chips. They form a pinching effect on the shredder mechanism to prevent the-rotary shafts from bending.

### BRIEF DESCRIPTION OF TIE DRAWINGS

The invention will become more fully understood from the detailed description given herein below illustration only, and thus is not limitative of the present invention, and wherein:

FIG. 1 is a three-dimensional view of the invention;

FIG. 2 is a three-dimensional of the disclosed lock element; and

FIG. 3 is a cross-sectional view of the invention.

### DETAILED DESCRIPTION OF THE INVENTION

The present invention will be apparent from the following detailed description, which proceeds with reference to the accompanying drawings, wherein the same references relate to the same elements.

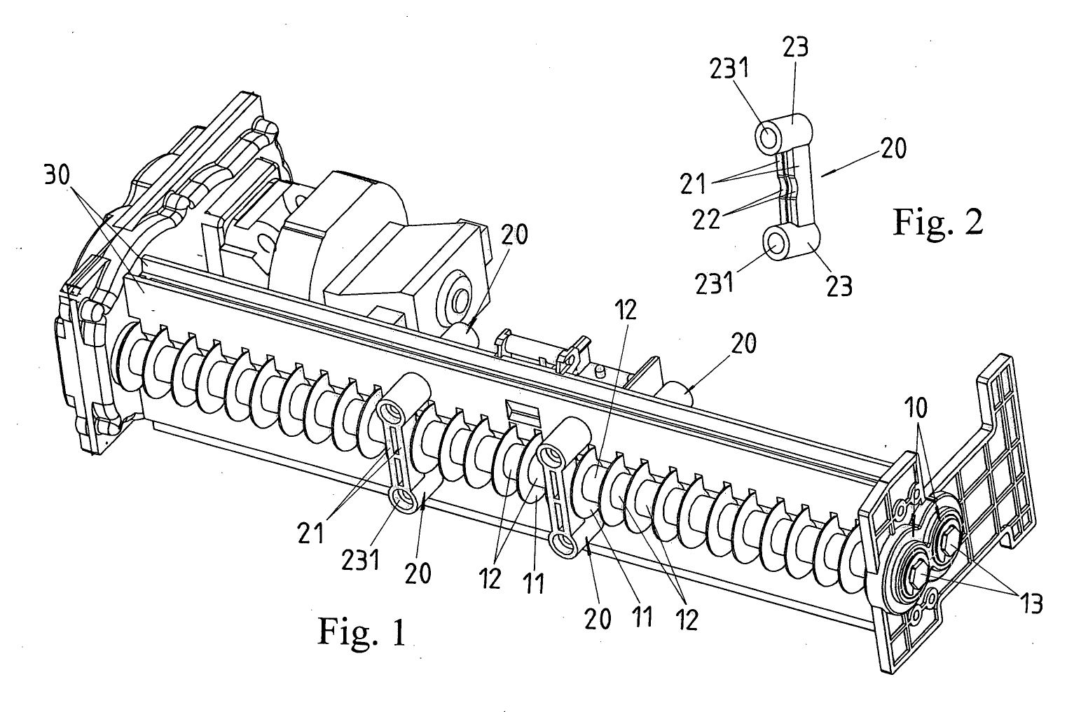

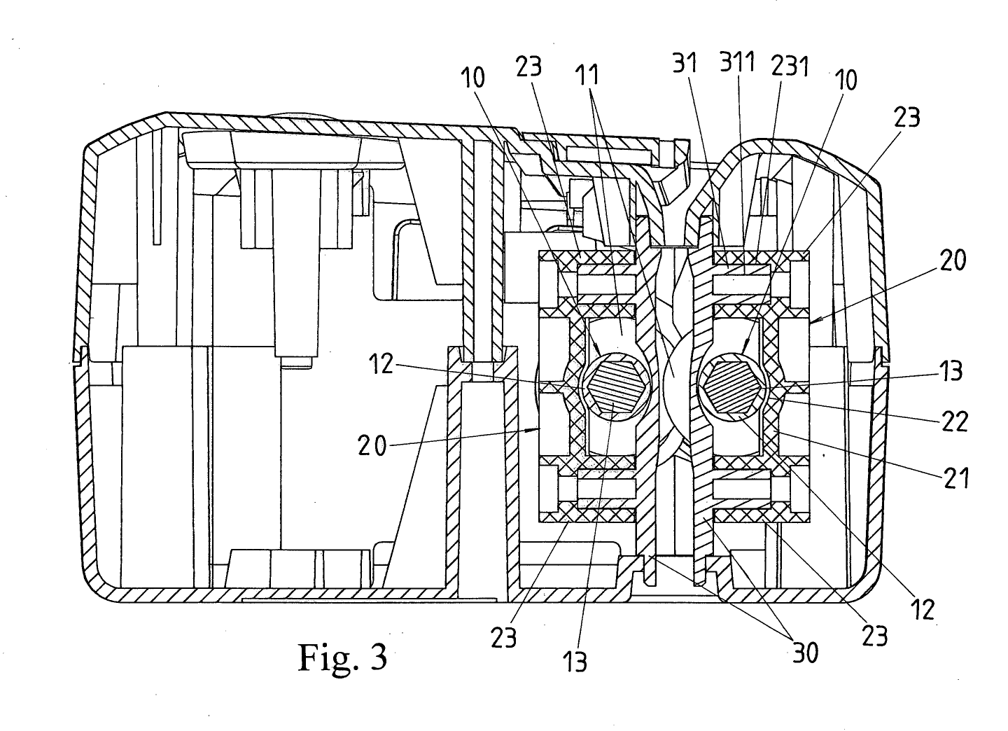

As shown in FIGS. 1 to 3, the shredder mechanism 10 disposed in a frame includes cutting blades 11 mounted on the rotary shafts 13, spacer rings 12, and paper guiding chips 30. A motor and a gearbox drive the two parallel rotary shafts 13 to rotate in opposite directions. The passing paper is then cut into stripes or chips.

If the user inserts too much paper into the paper inlet of the shredder and the paper enters the shredder mechanism, the cutting blades 11 may stop due to a paper jam. In this case, the rotary shafts 13 bend outward due to overloading. If no appropriate supporting components are provided on the outer sides of the rotary shafts 13 to balance the bending moment, the rotary shafts 13 may even break, making the shredder out of order.

Please refer to FIG. 2. The lock elements 20 for preventing the rotary shafts from bending are fixed on the paper guiding chips 30 from both sides of the shredder mechanism toward the radial direction of the rotary shafts 13. The lock elements 20 thus pinch the shredder mechanism 10, achieving the goal of preventing the rotary shafts 13 from bending. The lock element 20 basically has a U shape, including two horizontal fixing ends 23 and one vertical supporting arm 21. The fixing end 23 has a screw hole 231 for it to be fixed onto a connecting part 31 and a screw hole 311 at the corresponding position on the paper guiding chip 30. A screw is used to fix the lock element 20 on the paper guiding chip 30. The vertical supporting arm 21 of the lock element 20 stride and urge on the outer side of the spacer rings 12 of the shredder mechanism 10. In order for the supporting arm 21 to attach outside the spacer rings 12, the supporting arm 21 further has a concave portion 22 corresponding to the arc of the spacer ring 12.

In practice, the lock elements 20 are used in pairs and fixed to the paper guiding chips 30 in a symmetrical way. They form a pinching effect on the shredder mechanism 10 to prevent the rotary shafts 13 from bending. At least one pair of the lock elements 20 is required. More pairs can be used in necessary.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A shaft bending prevention mechanism including a lock element for preventing at least one of the rotary shafts of a shredder from bending,
said shredder comprising:
a frame; and
a shredder mechanism, which is disposed on the frame and includes: cutting blades mounted on two parallel rotary shafts, spacer rings, and paper guiding members, wherein the rotary shafts are driven by a motor and a gear box to rotate in opposite directions to shred passing paper into stripes or chips, said paper guiding members extending between said rotary shafts to guide said passing paper to said cutting blades; and
said shaft bending prevention mechanism comprising:
a lock element fixed to one of the paper guiding members on a respective side of the shredder mechanism and extending in a radial direction towards said at least one of the rotary shafts, thereby capturing said one of the rotary shafts between the lock element and said one of the paper guiding members to which the lock element is fixed, whereby said lock element and said one of the paper guiding members provide a pinching effect on the the respective one of the rotary shafts to prevent the respective shaft from bending.

2. The shaft bending prevention mechanism including a lock element for preventing at least one of the rotary shafts from bending as in claim 1, wherein the lock element has a U shape, including two horizontal fixing ends fixed to said one of said paper guiding members and one vertical supporting arm.

3. The shaft bending prevention mechanism including a lock element for preventing at least one of the rotary shafts from bending as in claim 2, wherein each of the fixing ends has a screw hole that matches a connecting part and a screw hole at a corresponding position on said one of the paper guiding members, and a screw is used to fix the lock element on said one of the paper guiding members.

4. The shaft bending prevention mechanism including a lock element for preventing at least one of the rotary shafts from bending as in claim 2, wherein the supporting arm engages an outer side of one of the spacer rings.

5. The shaft bending prevention mechanism including a lock element for preventing at least one of the rotary shafts from bending as in claim 4, wherein the supporting arm has a concave portion corresponding to an arc of the outer side of the spacer ring.

6. The shaft bending prevention mechanism including a lock element for preventing at least one of the rotary shafts from bending as in claim 1, further comprising a plurality of said lock elements on each side of said frame, wherein the lock elements are used in pairs and fixed in a symmetrical way on the paper guiding members.
